(19) United States
(12) Patent Application Publication
(10) Pub. No.: US 2007/0047890 A1
(43) Pub. Date: Mar. 1, 2007

(54) System and Method for Binding Materials

(76) Inventor: Wayne S. Richey, Mesa, AZ (US)

Correspondence Address: QUARLES & BRADY LLP, 411 E. WISCONSIN AVENUE, SUITE 2040, MILWAUKEE, WI, 53202-4497, US

(21) Appl. No.: 11/466,143

(22) Filed: Aug. 22, 2006

Related U.S. Application Data
(60) Provisional application No. 60/710,473, filed on Aug. 23, 2005.

(51) Int. Cl. G02B 6/00

(52) U.S. Cl. 385/134

(57) ABSTRACT

A binder for securing a bundle of fibers includes a bracket having opposing side walls extending from a base to form a trough configured to receive a bundle of fibers. The binder also includes a cover configured to be positioned within the trough over the bundle of fibers to secure the bundle of fibers within the bracket when the opposing side walls of the bracket are crimped over at least a portion of the cover.

### CROSS-REFERENCE TO RELATED APPLICATIONS

This application claims the benefit of U.S. Provisional Patent Application No. 60/710,473 filed Aug. 23, 2005, and entitled “Binder For Linear Fibrous Materials.”

### STATEMENT REGARDING FEDERALLY SPONSORED RESEARCH OR DEVELOPMENT

--

### BACKGROUND OF THE INVENTION

This invention relates generally to the packaging, processing, handling, and identification of linear fibrous materials and, in particular, to a system and method for packaging, processing, handling, and identification of materials, such as those used within the fly tying industry.

Fly tying is known from the first century and most likely originated some time well before that, possibly when bronze hooks were first developed in Egypt around 300 B.C. As a hobby, fly tying is practiced by men and women of all ages and nationalities. In addition, the commercial production of fishing flies is a multi-million dollar business spread around the globe.

Fly tying materials were originally gathered from items of nature such as hair, fur, plant fibers, and so on. Currently a large number of fly tying materials are synthetic in origin; many of these were originated for the fabric and carpet industries. Because a large percentage of these synthetic materials are linear fibers of thin diameter, there has arisen a distinct need to manage these fibers during processes such as washing, dyeing, drying, and others, packaging for sale, and during the fly tying process. Until now, no uniquely distinctive method has been developed for the specific management of such materials during their processing, packaging, and use. All existing managing techniques have been derived from other industries, and all of them lack one or more needed characteristics to make them ideally suited to the particular needs of the fly tying hobbyist and the fly tying industry.

For example, most linear fibers used in fly tying are processed using a variety of securing mechanisms specific to traditional textile industries. Thereafter, the fibers are cut to a specified length, bundled, and then secured at the midpoint or at a region displaced from the end of the fiber bundle. Hence, a first securing mechanism is used to hold the fibers during processes such as washing, dying, drying, and the like and then another securing mechanism is used to hold the fibers for packaging and distribution to the consumer. For example, to secure a bundle of fibers after being cut from the manufacturing grouping, a stiff wire, a “zip tie”, or other similar strap is used. In a few instances one end of the bundle is heated to fuse the ends of the fibers to hold them together.

Once secured in a bundle, store-display packaging is provided. In many cases, the packaging is little more than a tag or label that is secured to the bundle through a piece of string attached to the securing wire. In other cases, a cellophane bag may be used to surround the secured bundle and a label affixed to the bag. The label often provides a variety of information about the manufacturer and the fibers held in the bundle, such as name, model number, color, and the like. While these labels provide product information to the consumer during a store purchase, they are often removed or lost after leaving the store. For example, if the label is affixed to a cellophane bag containing the bundle, the user is inclined to discard the label along with the bag since there is no means for associating the label with the bundle thereafter. Likewise, if the label is secured to the bundle through a string, the string may break or otherwise become dislodged from the bundle during typical fly tying activities.

Moreover, beyond the shortcomings of these bundling/packaging techniques that are experienced by the consumer, the manufacturing processes, bundling processes, and packaging processes require separate and distinct materials. This reduces the efficiency of the manufacturing, bundling, and packaging processes and, ultimately, raises the cost of the product to the consumer.

Therefore, it would be desirable to have a system and method for securing fibers that is capable of meeting the needs of manufacturing processes, packaging/labeling processes, and fly-tying consumers. It would be desirable to have a system and method for securing a bundle of fibers for fly tying during manufacturing processes that also facilitates organizing the bundled fibers, attaching the bundles to a fly tying bench or other specialized fixture, and including identifiers that remain associated with the bundled fibers even after removal from store-display packaging.

### SUMMARY OF THE INVENTION

The present invention provides a system and method for securely holding bundled linear fibers so that the bundle may be easily washed, dyed, dried, and/or otherwise processed, organized by material composition, and secured to a fly tying bench or to a specifically designed fixture. The present invention also provides a system and method for affixing a printed label that permits the user to readily identify the bundled fibers by fiber name, fiber color, and other specifications even once the bundle has been removed from the store-display packaging.

In accordance with one embodiment, a binder is disclosed for securing a bundle of fibers that includes a bracket having opposing side walls extending from a base to form a trough configured to receive a bundle of fibers. The binder also includes a cover configured to be positioned within the trough over the bundle of fibers to secure the bundle of fibers within the bracket when the opposing side walls of the bracket are crimped over at least a portion of the cover.

In accordance with another embodiment, a method of securing a bundle of fibers is disclosed that includes arranging a bundle of fibers in a trough formed by a bracket having a base and opposing side walls and arranging a cover within the trough over the bundle of fibers. The method also includes crimping the side walls of the bracket over the cover to secure the cover against the bundle of fibers.

In accordance with yet another embodiment, a system for securing a bundle of fibers is disclosed that includes a bracket having a base and opposing side walls extending from a first end engaged with the base to a second end to form a trough. The bundle also includes a bundle of fibers having a portion extending through the trough and a cover arranged within the trough to extend over the portion of the bundle of fibers extending through the trough. The second end of the opposing side walls wraps over the cover to secure the cover against the portion of the bundle of fibers within the trough.

Various other features of the present invention will be made apparent from the following detailed description and the drawings.

### BRIEF DESCRIPTION OF THE DRAWINGS

The invention will hereafter be described with reference to the accompanying drawings, wherein like reference numerals denote like elements, and:

FIG. 1 is a perspective view of a bracket for securing fiber bundles in accordance with the present invention;

FIG. 2 is an end view of the bracket of FIG. 1;

FIG. 3 is a plan view of the bracket of FIGS. 1 and 2;

FIG. 4 is a bottom view of the bracket of FIGS. 1-3;

FIG. 5 is a perspective view of a partially assembled binder in accordance with the present invention that includes the bracket of FIGS. 1-5 and a cover arranged over a plurality of fibers;

FIG. 6 is a perspective view of the binder of FIG. 5 in an assembled form; and

FIG. 7 is a perspective view of the binder of FIG. 6 showing a label affixed thereto.

### DETAILED DESCRIPTION OF THE PREFERRED EMBODIMENT

The present invention generally relates to the bundling, processing, organizing, storage, and identification of linear fibers and, in particular, to a system and method for bundling, processing, organizing, and for storage and identification of linear fibers used in fly tying, both by the hobbyist and by commercial fly tying firms. The fibers may be of a wide variety of types such as Mylar, Polyester, Nylon, Dacron, Antron, and the like. Mylar, Dacron, and Antron are registered trademarks of Du Pont De Nemours and Co. of Delaware. Accordingly, the following description is made with respect to fiber processing, fiber packaging, and consumer use of fibers designed for fly tying endeavors. However, it is contemplated that these specific applications and contexts are described for exemplary purposes and that the present invention is applicable to a wide variety of applications and uses.

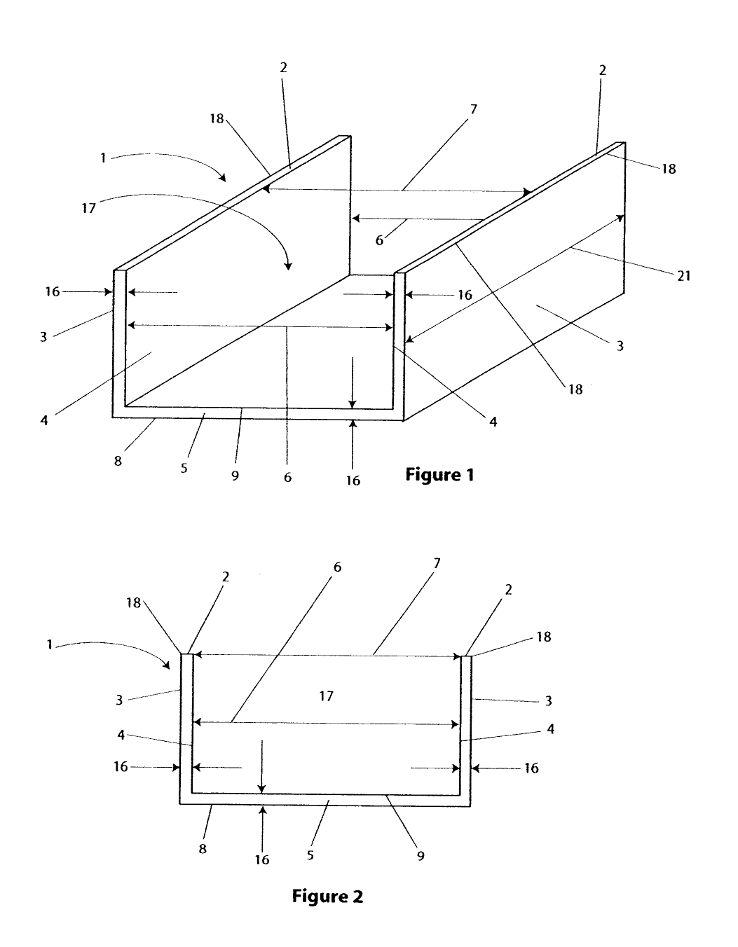

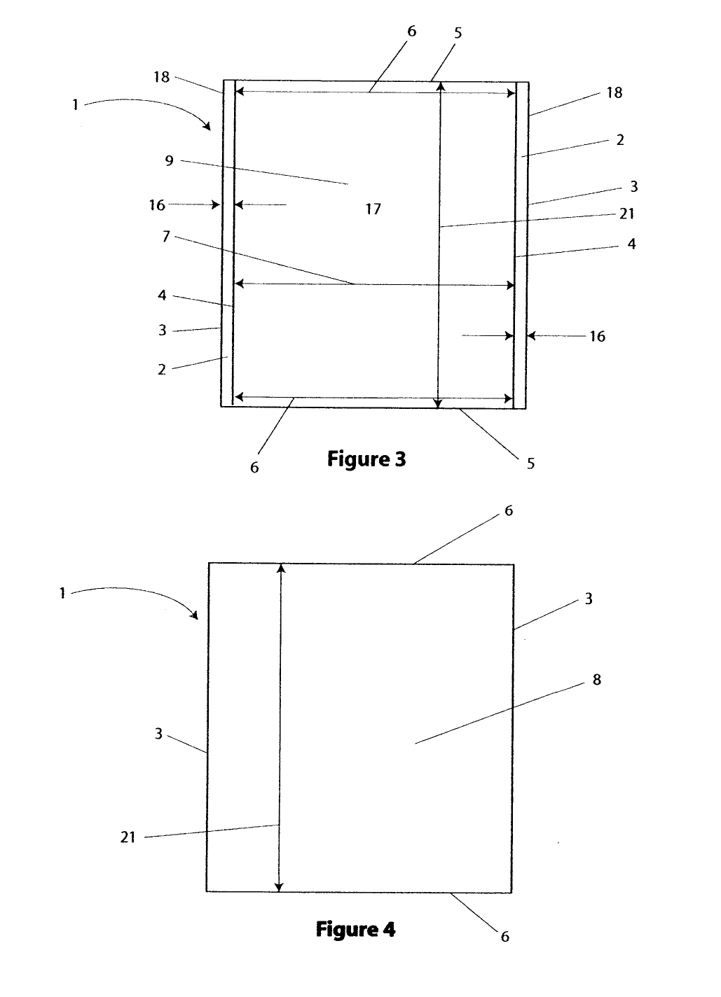

Referring now to FIGS. 1-7, a binder 15 advantageously permits the bundling of fibers 12, for example, linear fibers, in such a way as to readily permit processing as necessary, to organize the bundled fibers by composition, color, or other features thereof, to store the fibers for easy access, and for identification of the bundle once it is removed from the store-display packaging.

The fibers 12 used in fly tying are typically a predetermined length for ease of packaging and use by a consumer during fly tying. Within the example of fly tying applications, the fibers 12 may be formed from a wide variety of materials that have many uses in the art of fly tying. However, fly tying fibers typically have two common characteristics. First, the fibers are typically linear. Second, the fibers are provided for sale in a bundle. The number of fibers in a bundle varies according to the chemical composition and physical cross-sectional area of each fiber. However, as will be described, the present invention permits secure fiber bundles to be quickly and easily created that have a standard number of fibers per bundle.

The present binder 15 includes two primary components. The first component is a bracket 1 that, as will be described, acts as a clip. The second component is a cover 10 that, as will be described, is designed to be coupled with the housing 1 to secure the fibers 12 in a bundle.

In accordance with one embodiment, the bracket 1 is formed from a substantially ridged material, such as a metal, like steel or aluminum. In the case of metals like steel, the metal may be left uncoated or it may be coated with any number of commercially available products that minimize or prevent oxidation of the metal. However, it is also contemplated that the bracket 1 may also be made of other suitable materials such as plastics or other metals.

The bracket 1 has two side walls 2 and a base 5. The side walls 2 and the base 5 of the bracket 1 have a thickness 16. Hence each of the side walls 2 has an exterior surface 3 and an interior surface 4 and the base 5 has an exterior surface 8 and an interior surface 9. This arrangement of two side walls 2 and a base 5 produces an open-ended structure, the bracket 1, having two open ends 6 and an open top 7. Hence, the space 17 enclosed by the two sidewalls 2 and the base 5 has a trough-shaped or a “U”-shaped configuration.

As addressed above, the second portion of the binder 15 includes a cover 10. The cover 10 may be formed from a variety of materials, including metals, plastics, fabrics, and the like. The cover 10 includes opposing sides 11, 19 that extend in parallel to form a substantially planar surface. However, it is contemplated that in the case of fabrics or materials of reduced rigidity, the planar surface may be deformed, such as during crimping, as will be described below.

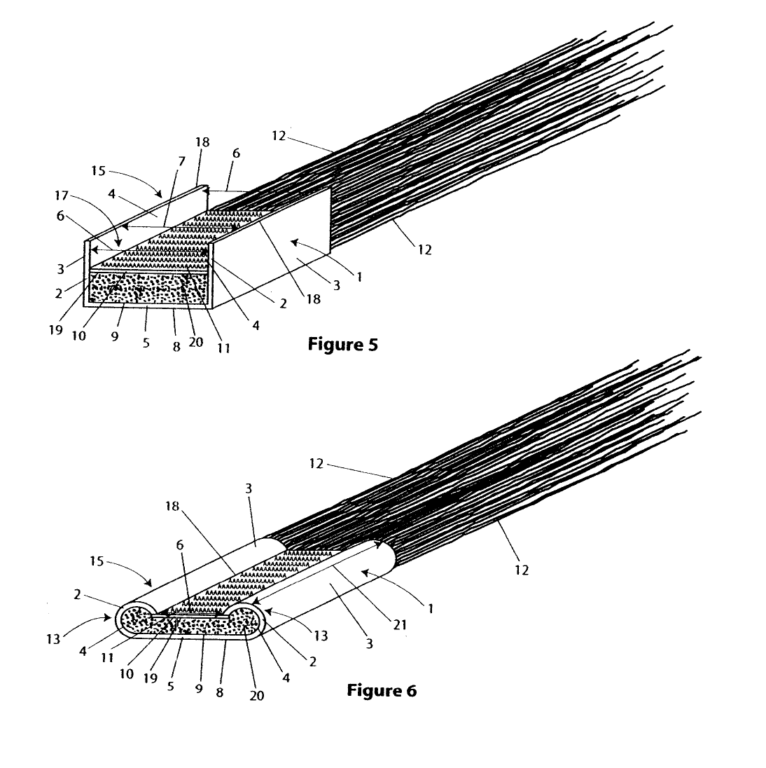

As stated above, the bracket 1 and cover 10 are designed to be coupled together to form a binder 15 configured to hold a plurality of fibers 12. In particular, the fibers 12 are placed into space 17 within the bracket 1. The fibers 12 are placed into the open space 17 between the sidewalls 2 such that the ends 20 of the fibers 12 are aligned with one of the open ends 6 of the bracket 1. Particular fibers, processes, or manufacturers may require that the binder 15 be placed at some other position along the length of the fibers 12. The fibers 12 rest on the interior surface 9 of the base 5 and against the interior surfaces 4 of the side walls 2, as shown in FIG. 5.

The cover 10 is then placed into the space 17 over the bundle of fibers 12. In particular, the cover 10 is positioned on the fibers 12 such that the one side 11 faces upward toward the open top 7 of the bracket and the opposing side faces inward toward the fibers 12. As will be described below, it is contemplated that at least the upwardly facing side 11 may include an adhesive. However, it is contemplated that both sides 11, 19 of the cover 10 may include adhesives.

Once the bracket 1, the fibers 12, and the cover 10 are assembled, the side walls 2 of the bracket 1 can be crimped tightly inward such that the distance 6 between the top edges 18 of the side walls 2 is decreased. Accordingly, the top edges 18 of the side walls 2 are forced down to rest firmly on the cover 10. This act of crimping also compresses the enclosed portion 20 of the linear fibers 12 until the enclosed portion is tightly and securely clamped between the interior surfaces 4 of the crimped side walls 2, the interior surface 9 of the base 5, and the inner side 19 of the cover 10.

In accordance with one embodiment of the present invention, the cover 10 has a width matched to a width of the open end 6 of the open top 7 of the bracket 1. This width and the amount of the side walls 2 that is wrapped over the cover 10 are selected so that, when the bracket 1 is filled with a predetermined amount of fibers 12, a portion of the cover 10 is exposed.

In this regard, the specific sizing of the bracket 1 is selected to accommodate a predetermined number of fibers sold in a bundle. A manufacturer may quickly and easily determine a desired quantity of fibers 12 to be bundled by using the bracket 1 as a measuring device. That is, a quantity of fibers 12 may be positioned within the bracket 1 and, based on the amount of space filled or remaining in the bracket, the manufacturer can determine whether the correct quantity of fibers 12 has been selected. In accordance with one embodiment, the bracket 1 may have a length of ⅝ of an inch. Accordingly, the side walls 2 may be ¼ of an inch tall along the exterior surface 3 and the base 5 may be ½ of an inch wide across the exterior surface 8. However, it is contemplated that a wide variety of dimensions may be used or selected to accommodate different numbers of fibers 12 per bundle or different fiber types. In particular, it is contemplated that the sizing of the bracket 1 and cover 10 may be selected based on the size and features of the fiber being bundled. That is, since the size of the fibers 12 vary greatly with type, such as from 6 denier or smaller to 0.125 inches or larger, the size of the bracket 1 and cover 10 may be selected to provide space for a given quantity of fiber 12 so that a manufacturer can quickly and easily select a desired quantity of fiber 12 by using the bracket and/or cover as a measuring guide.

As stated above, it is contemplated that at least one of the opposing sides 11, 19 of the cover 10 may include an adhesive material that is designed to be exposed when the bracket 1 is crimped over the cover 10. The adhesive material may be a commercially available material, such as Velcro or other resilient adhesive material. Velcro is a registered trademark of Velcro Industries B.V. LTD LIAB CO of the Netherlands. For example, a fabric surface may be secured to at least one of the opposing sides 11, 19 to present hooks or loops extending therefrom that are typically formed of nylon. In this regard, when the fabric surface of the cover 10 is pressed together with a reciprocal surface (i.e., hooks engaged with loops or vice versa), the hooks and loops intertwine and form a strongly adhesive combination. Accordingly, the adhesive surface 11 of the cover 10 provides a surface by which the binder 15 may be attached to a fly tying bench or other specialized fixture.

Furthermore, it is contemplated that the adhesive material may extend along the other of the opposing sides 19 of the cover 10 that is designed to be pressed against the fibers 12 when the bracket 1 is crimped over the cover 10. In this regard, it is contemplated that the adhesive material may include the hook portion described above, which, when the bracket 1 is crimped over the cover 10, is forced down into the fibers 12 held by the binder 15. As such, the adhesive material arranged along the inner side 19 of the cover serves to further secure the fibers 12 within the binder 15, even in the event some fibers are removed or the crimping is less than preferred.

In accordance with one embodiment, the adhesive material may extend across an entire length 21 of the cover, which, as addressed above, may be matched to the length of the side walls 2 of the bracket 1. However, other widths and lengths of the adhesive material may be employed without changing the overall purpose and function of the binder 15.

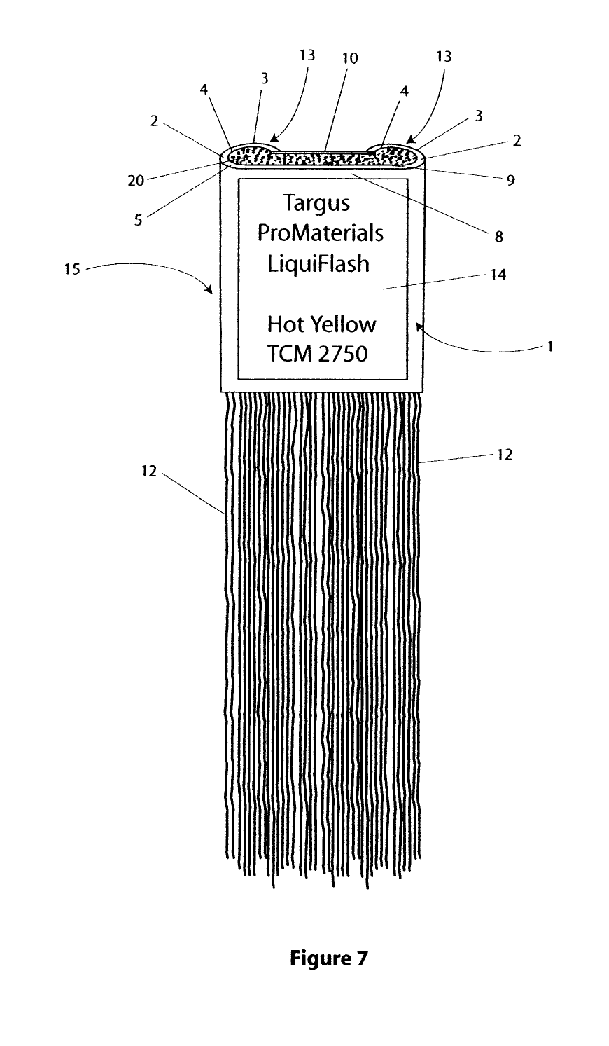

Referring now to FIG. 7, the exterior surface 8 of the base 5 of the bracket 1 provides an area where an identification label 14 may be added. As addressed above, the base 5 of the bracket 1 forms the exterior surface 8 that, in accordance with one embodiment, provides an area on which a label 14 may be affixed. The label 14 can present any information desired for the bundled fibers 12, such as fiber name, fiber color, or other manufacturer specifications and information.

The foregoing, and other advantages of the present invention, are realized in one aspect thereof in a device or binder for securely holding bundled linear fibers so that the bundle may be easily washed, dyed, dried and/or otherwise processed, organized by material composition, and secured to a fly tying bench or other specifically designed fixture. Additionally, the binder is designed to receive a printed label that permits the user to readily identify the bundled fibers. The label may include information such as fiber name, specific color, and other manufacturer specifications and is designed to remain with the fibers even once the bundle has been removed from the store-display packaging. The cover may include an adhesive material. The adhesive material may be resilient and may include nylon hooks and/or loops.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

We claim:

1. A binder configured to secure a bundle of fibers comprising:
a bracket having opposing side walls extending from a base to form a trough configured to receive a bundle of fibers; and
a cover configured to be positioned within the trough over the bundle of fibers the opposing side walls of the bracket are crimped over at least a portion of the cover to secure the bundle of fibers within the bracket.

2. The binder of claim 1 further comprising an adhesive attached to the cover.

3. The binder of claim 2 wherein the adhesive extends along a portion of the cover that is exposed when the opposing side walls of the bracket are crimped over at least a portion of the cover.

4. The binder of claim 2 wherein the adhesive extends along a portion of the cover engaged with the fibers.

5. The binder of claim 2 wherein the adhesive includes at least one of a plurality of hooks and a plurality of loops.

6. The binder of claim 2 wherein the adhesive is configured to resiliently engage another surface to secure the binder to the another surface.

7. The binder of claim 1 further comprising a label affixed to the base to identify characteristics of at least one of the bundle of fibers and a manufacturer of the bundle of fibers.

8. The binder of claim 1 wherein the bracket and cover are sized to receive a predetermined bundle size to facilitate selection of a predetermined number of fibers for the bundle of fibers.

9. The binder of claim 1 wherein the binder is configured to secure the bundle of fibers during fiber manufacturing processes, retail display, and consumer use.

10. The binder of claim 9 wherein the manufacturing processes include washing, dying, and drying fibers in the bundle of fibers.

11. A method of securing a bundle of fibers comprising:
arranging a bundle of fibers in a trough formed by a bracket having a base and opposing side walls;
arranging a cover within the trough over the bundle of fibers; and
crimping the side walls of the bracket over the cover to secure the cover against the bundle of fibers.

12. The method of claim 11 further comprising arranging an adhesive along at least one side of the cover that is exposed when the side walls of the bracket are crimped over the cover to present a resilient securing surface for affixing the bundle of fibers to another surface.

13. The method of claim 12 wherein the adhesive includes at least one of a plurality of hooks and a plurality of loops.

14. The method of claim 11 further comprising arranging an adhesive along at least another side of the cover that engages the bundle of fibers when the side walls of the bracket are crimped over the cover to secure the bundle of fibers within the bracket.

15. The method of claim 11 further comprising affixing a label to the bracket to identify characteristics of at least one of the bundle of fibers and a manufacturer of the bundle of fibers.

16. The method of claim 11 further comprising sizing the bracket and the cover to receive a predetermined bundle size to facilitate selection of a predetermined number of fibers for the bundle of fibers.

17. A bundle of fibers comprising:
a bracket having a base and opposing side walls extending from a first end engaged with the base to a second end to form a trough;
a bundle of fibers having a portion extending through the trough;
a cover arranged within the trough to extend over the portion of the bundle of fibers extending through the trough; and
wherein the second end of the opposing side walls wraps over the cover to secure the cover against the portion of the bundle of fibers within the trough.

18. The bundle of claim 17 further comprising a resilient adhesive material arranged over a portion of the cover configured to secure the bundle of fibers to a receiving surface.

19. The bundle of claim 18 wherein the resilient adhesive material includes at least one of plurality of hooks and a plurality of loops.

20. The bundle of claim 17 wherein the bracket includes a label surface configured to receive a label identifying characteristics of at least one of the bundle of fibers and a manufacturer of the bundle of fibers.
